(19) United States
(12) Patent Application Publication
(10) Pub. No.: US 2013/0044225 A1
(43) Pub. Date: Feb. 21, 2013

(54) NETWORK CAMERA AND METHOD OF CONTROLLING LIGHTING THEREOF

(71) Applicant: Ki Kyung JEON, Seoul (KR)

(72) Inventor: Ki Kyung JEON, Seoul (KR)

(73) Assignee: LG INNOTEK CO., LTD., Seoul (KR)

(21) Appl. No.: 13/588,564

(22) Filed: Aug. 17, 2012

(30) Foreign Application Priority Data
Aug. 17, 2011 (KR) 10-2011-0081515

(51) Int. Cl. H04N 9/68

(52) U.S. Cl. 348/207.1; 348/E09.053

(57) ABSTRACT

Disclosed are a network camera and a method of controlling lighting thereof. The network camera includes a lighting part including at least one LED module, an image sensor part converting an image, which is input from an outside, into a color signal and measuring illuminance by using the converted color signal, and a controller adjusting brightness of the lighting part based on information of the illuminance received from the image sensor.

### CROSS-REFERENCE TO RELATED APPLICATION

This application claims the benefit under 35 U.S.C. §119 of Korean Patent Application No. 10-2011-0081515, filed Aug. 17, 2011, which is hereby incorporated by reference in its entirety.

### BACKGROUND

The disclosure relates to a network camera having infrared LED lighting. More particularly, the disclosure relates to a network camera capable of automatically adjusting the brightness of the infrared LED lighting by using an image sensor.

Recently, security markets have been continuously expanded, and, particularly, the importance on night surveillance has been increased. In addition, the application fields of the night surveillance, such as night license plate recognition, the inhibition of night crimes, and the inhibition of crimes on a night road, have been continuously expanded. In other words, the needs to exactly identify a subject contained in an image at night having no light by monitoring, storing, and playing back the image have been increased.

Accordingly, recently, a network camera employs infrared LED lighting in order to determine a night image. In other words, a subject can be identified by using a camera employing the infrared LED lighting even under the situation having no light.

FIG. 1 is a block diagram showing a network camera according to the related art. As shown in FIG. 1, the network camera includes a controller, an image sensor, an illuminance sensor, and a lighting part, and the lighting part includes a plurality of infrared light emitting diodes (IR LED).

The network camera controls the lighting part by using the illuminance sensor. In other words, the illuminance sensor measures the quantity of light input through a camera lens so that the IR LEDs are adjusted. For example, when surroundings are darkened in the process of shifting daytime to nighttime, the illuminance sensor of the network camera senses ambient brightness so that the brightness of the lighting part can be automatically adjusted. In this case, the illuminance sensor may include a photodiode.

However, when the illuminance sensor is applied to the network camera, the realization of a circuit may be complicated, and component cost may be increased. In addition, when the network camera is designed, problems may occur due to the volume of the illuminance sensor occupying the inner part of the network camera. Accordingly, the solutions to the problems are strongly required.

### BRIEF SUMMARY

The disclosure provides a network camera capable of automatically adjusting the brightness of infrared LED lighting, and a method of controlling the same.

In addition, the disclosure provides a network camera capable of adjusting the brightness of the infrared LED lighting by using an image sensor and a method of controlling the same.

Technical objects of the embodiment may not be limited to the above object and other technical objects of the embodiment will be apparent to those skilled in the art from the following description.

According to the disclosure, there is provided a network camera including a lighting part including at least one LED module, an image sensor part converting an image, which is input through a lens part, into an R/G/B signal and measuring illuminance by using the R/G/B signal, and a controller adjusting brightness of the lighting part based on information of the illuminance received from the image sensor.

According to the disclosure, there is provided a method of controlling lighting of a network camera. The method includes dividing an image, which is input from an outside, into a brightness (Y) signal and a color difference (R-Y/B-Y) signal, converting a Y/R-Y/B-Y signal into an R/G/B signal by using an RGB matrix, measuring illuminance by analyzing an RGB histogram based on the R/G/B signal, and automatically adjusting brightness of a lighting part based on information of the measured illuminance.

As described above, the network camera according to the embodiment can automatically adjust the brightness of the IR LED lighting through image sensors without an additional illuminance sensor. Accordingly, the increase problem of the product cost and the problem related to a design of the inner part of the network camera, which are caused by the use of the illuminance sensor, can be solved.

Meanwhile, other various effects of the disclosure will be directly or indirectly disclosed in the following detailed description of the disclosure.

### BRIEF DESCRIPTION OF THE DRAWINGS

FIG. 1 is a block diagram showing a network camera according to the related art;

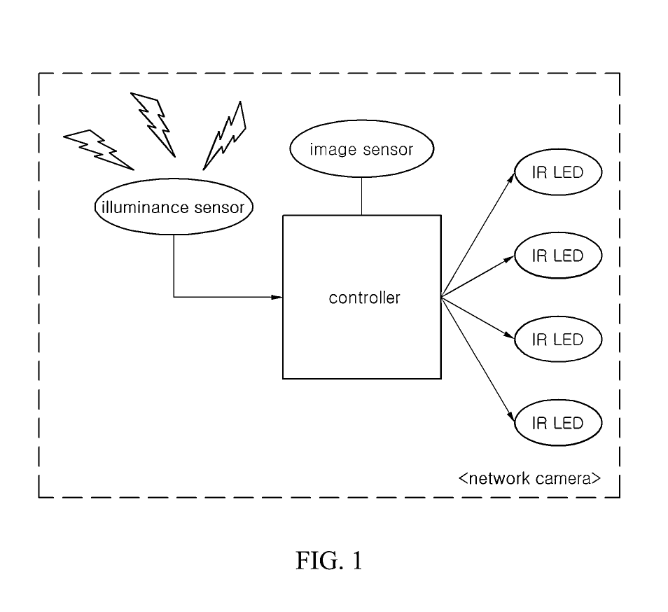

FIG. 2 is a schematic view showing an image monitoring system according to the embodiment of the disclosure;

FIG. 3 is a block diagram schematically showing the structure of a network camera according to the embodiment of the disclosure;

FIG. 4 is a block diagram showing an image sensor according to the embodiment of the disclosure; and

FIG. 5 is a flowchart showing a method of controlling the brightness an infrared LED lighting device according to the embodiment of the disclosure.

### DETAILED DESCRIPTION

Hereinafter, the embodiments will be described with reference to accompanying drawings in detail so that those skilled in the art to which the invention pertains can easily realize the embodiments. However, the embodiments may have various modifications without limitation.

However, those skilled in the art should comprehend that the disclosure is not limited to a specific embodiment, but all modifications, equivalents and alternatives are included in the technical spirit and scope of the disclosure.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention. Similarly, the second component may be named as the first component. In addition, the term “and/or” refers to the combination of components having the meaning of the plural number or one of the components.

Exemplary embodiments of the disclosure will be described in more detail with reference to accompanying drawings. In the following description, the same reference numerals will be assigned to the same components for the obvious comprehension of the embodiment, and the same components will not be repeatedly described in order to avoid redundancy.

The disclosure provides a network camera capable of automatically adjusting the brightness of infrared LED lighting by using an image sensor.

Hereinafter, the embodiment of the disclosure will be described with reference to accompanying drawings.

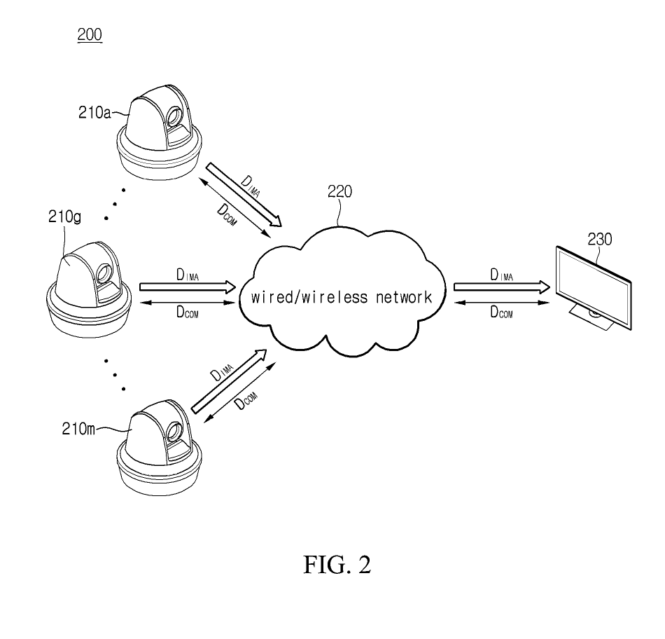

FIG. 2 is a schematic view showing an image monitoring system 200 according to the embodiment of the disclosure.

Referring to FIG. 2, the image monitoring system 200 includes a plurality of network cameras 21a, . . . and 210m, a wired/wireless network 220, and a control room terminal 230.

The network cameras 21a, . . . and 210m take images in the unit of a mega-pixel and store the images. The network cameras 21a, . . . and 210m convert the stored image data into an analogue image signal or a digital image signal to be output. The network cameras 21a, . . . and 210m provide the image data to the control room terminal 230 in real time over the wired/wireless network 220.

In detail, the network cameras 21a, . . . and 210m communicate with the control room terminal 230 through a communication channel DCOM while transmitting live-view motion picture data to the control room terminal 230 through an image data channel DIMA.

Naturally, only one network camera may communicate with the control room terminal 230 instead of a plurality of network cameras, or one network camera or the network cameras may communicate with a plurality of terminals. In other words, various modifications of the embodiment are possible.

In addition, the network cameras 21a, . . . and 210m construct a communication network based on Bluetooth, or Zigbee to make short-range communication with each other. In this case, the network cameras 21a, . . . and 210m may transceive a specific event signal therebetween instead of image data.

In addition, since each of the network cameras 21a, . . . and 210m includes an IR LED lathing device, each of the network cameras 21a, . . . and 210m can take images at night.

The control room terminal 230 provides the images received from the network cameras 21a, . . . and 210m to a user or a surveillant in real time. Then, the user or the surveillant performs a surveillance work based on the images provided in real time. In this case, the user or the surveillant can enlarge or downsize an image input from a specific camera according to necessities.

In addition, although FIG. 2 shows the control room terminal 230 having the shape similar to the shape of a computer, the disclosure is not limited thereto. The control room terminal 230 may include various devices having a display. The control room terminal 230 may store the live-view motion picture acquired from a surveillance camera if necessity.

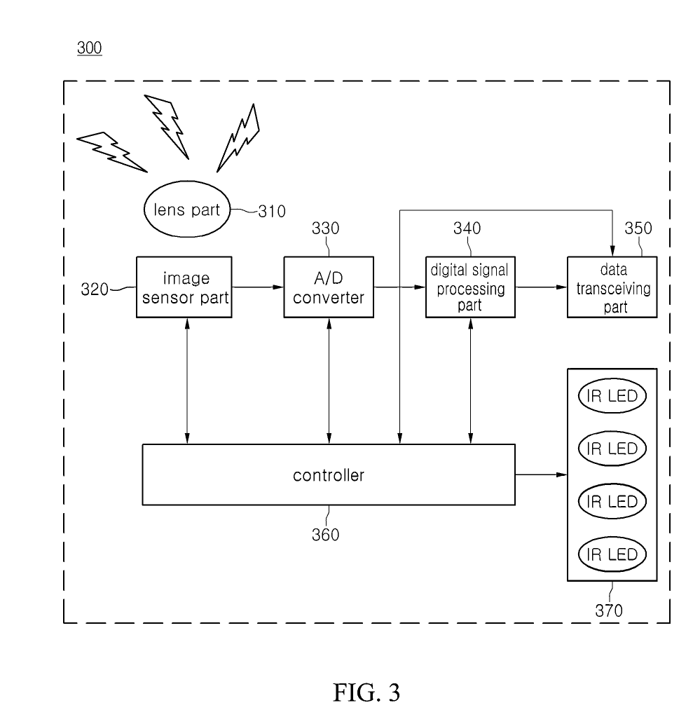

FIG. 3 is a block diagram schematically showing the structure of a network camera 300 according to the embodiment of the disclosure.

Referring to FIG. 3, the network camera 300 includes image photographing parts 310 and 320, an A/D converter 330, a digital signal processing part 340, a data transceiving part 350, a controller 360, and a lighting part 370. In the following description, the details of a part of operations of the network camera 300 that are not related to the disclosure will be omitted.

The image photographing parts 310 and 320 photograph a subject in the form of a mega-pixel image. The image photographing parts 310 and 320 includes a lens part 310 including a zoom-lens and an image sensor part 320 to create image data from incident light passing through the lens part 310.

The image sensor part 320 creates analog data from light input through the lens part 310, and the A/D converter 330 converts the analog data output from the image sensor part 320 into digital data.

Naturally, the A/D converter 330 may not be provided according to the characteristics of the image sensor part 320. For example, a charge coupled device (CCD) sensor creates analog data. In contrast, a complementary metal oxide semiconductor (CMOS) sensor creates digital data. Accordingly, if the image sensor part 320 includes the CMOS sensor, the A/D converter 330 may be omitted.

The image data output from the image sensor part 320 may be input to the digital signal processing part 340 through a memory (not shown), or may be directly input to the digital signal processing part 340 without passing through the memory (not shown). In addition, the image data may be input to the controller 360 according to the requirement or the specification of the user. In this case, the memory (not shown) includes a ROM or a RAM.

The digital signal processing part 340 may perform digital signal processing such as gamma correction or white balance adjustment if necessary. The image data output from the digital signal processing part 340 are stored in the memory (not shown) or transmitted to the data transceiving part 350.

The data transceiving part 350 transmits image data to the control room terminal 230 through the wired/wireless network 220 so that an image can be displayed on the display of the control room terminal 230. In this case, the image may refer to one-frame image of the live-view motion picture which is a real-time motion picture.

The lighting part 370 supplies lighting for night surveillance of the network camera. In particular, according to the present embodiment, the lighting part 370 automatically adjusts the lighting brightness according to the brightness variation of an external environment.

The lighting part 370 serves as an LED module including a plurality of LEDs, and includes a plurality of infrared LEDs. In this case, the LED module of the lighting part 370 may be arranged in different forms according to the usage and the shape of the network camera.

The controller 360 controls the overall operations of the network camera. In particular, according to the present embodiment, the controller 360 automatically adjusts the brightness of the lighting part 370 by using information of illuminance measured by the image sensor part 320.

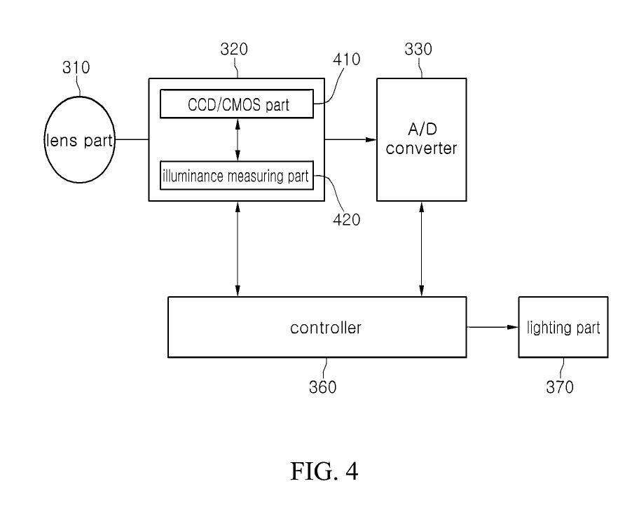

FIG. 4 is a block diagram showing an image sensor according to the embodiment of the disclosure.

Referring to FIG. 4, the image sensor part 320 includes a CCD/CMOS part 410 and an illuminance measuring part 420.

The CCD/CMOS part 410 is an image sensing device to take an optical image of a subject, which is incident through the lens part 31 and to create an image signal corresponding to the optical image. In this case, the image sensing device may include the CCD sensor or the CMOS sensor.

The CCD sensor and the CMOS sensor make a great difference in that the CCD sensor converts an optical signal into an analog image signal, and the CMOS sensor converts an optical signal into a digital image signal. Accordingly, if the CCD sensor is used as the image sensing device, the network camera further includes an A/D converter (not shown) between the image sensor part 320 and the digital signal processing part 340. Hereinafter, an example in which the CMOS sensor is used as the image sensing device will be described according to the present embodiment.

The CCD/CMOS part 410 divides an image input through the lens part 310 into a brightness (Y) signal and a color difference signal (R-Y/B-Y) and converts a Y/R-Y/B-Y signal into an R/G/B signal by using an RGB matrix. In this case, the CCD/CMOS part 410 outputs the R/G/B signal in the unit of a pixel. The R/G/B signal is provided to the A/D converter 330 and the illuminance measuring part 420.

The illuminance measuring part 420 measures the illuminance, which is ambient brightness, based on the input R/G/B signal. In this case, the illuminance measuring part 420 calculates the illuminance by analyzing an RGB histogram based on the input image signal. Meanwhile, the illuminance measuring part 420 extracts only a brightness component of the input image signal to calculate the illuminance.

The illuminance measuring part 420 can calculate the illuminance in the unit of one frame or in the unit of the preset number of frames. The illuminance measuring part 420 may calculate the illuminance with a preset time of period. Through the measuring of the illuminance, the network camera can exactly measure external brightness.

The controller 360 automatically adjusts the brightness of the lighting part 370 by using the illuminance information received from the illuminance measuring part 420. In this case, the controller 360 may previously store lighting brightness levels according to the variation of the illuminance in the form of a look-up table. Therefore, the controller 360 controls the lighting part 370 according to the brightness levels corresponding to measured illuminance values measured by the illuminance measuring part 420.

Meanwhile, although the look-up table is stored in the controller 360 according to the present embodiment, the disclosure is not limited thereto. In other words, the look-up table may be stored in an additional memory (not shown) instead of the controller.

In addition, the controller 360 can automatically adjust the brightness of the lighting part 370 by applying different voltage values or different current values according to the variation of surrounding illuminance. For example, the controller 360 can adjust the brightness of light by applying a pulse width modulation (PWM) signal to the LED module of the lighting part 370.

In addition, the controller 360 can individually control a plurality of LED modules provided in the lighting part 370. In this case, the controller 360 can adjust the brightness of the lighting part 360 by controlling an on/off operation of the LED modules.

As described above, the network camera according to the embodiment can automatically adjust the brightness of the IR LED lighting through the existing image sensors without an additional illuminance sensor.

Hereinafter, a method of controlling the lighting of the network camera will be described in detail.

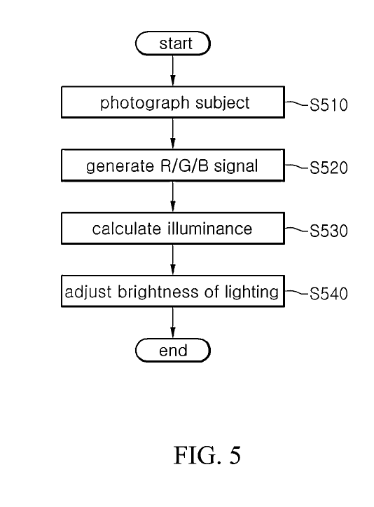

FIG. 5 is a flowchart showing the method of controlling the brightness of an IR LED lighting according to the embodiment of the disclosure.

Referring to FIG. 5, the network camera takes an image for a surveillance area in a step S510.

In a step S520, the network camera takes an optical image of a subject incident through a lens part and creates an image signal corresponding to the optical image. In other words, after dividing the image input through the lens part into a brightness signal Y and a color difference signal (R-Y/B-Y), a Y/R-Y/B-Y signal is converted into an R/G/B signal by using an RGB matrix.

The network camera measures the illuminance based on the R/G/B signal in a step S530. In other words, the network camera calculates the illuminance by analyzing an RGB histogram based on the input image signal. In this case, the network camera can calculate the illuminance in the unit of one frame or the preset number of frames. Through the calculation of the illuminance, the network camera can measure the present ambient brightness.

The network camera automatically adjusts the brightness of IR LED lighting by using the illuminance information in a step S540. In this case, the network camera may previously store brightness levels of lightening according to the variation of the illuminance in the form of a look-up table. Therefore, the network camera controls the brightness of the lighting according to the brightness levels corresponding to measured illuminance values.

As described above, according to the method of controlling the lighting of the network camera of the embodiment, the brightness of the IR LED lighting can be automatically adjusted by using existing image sensors without an additional illuminance sensor.

Although the exemplary embodiments of the disclosure have been described, it is understood that the disclosure should not be limited to these exemplary embodiments but various changes and modifications can be made by one ordinary skilled in the art within the spirit and scope of the disclosure as hereinafter claimed.

What is claimed is:

1. A network camera comprising:
a lighting part including at least one LED module;
an image sensor part converting an image, which is input from an outside, into a color signal and measuring illuminance by using the converted color signal; and
a controller adjusting brightness of the lighting part based on information of the illuminance received from the image sensor.

2. The network camera of claim 1, wherein the image sensor part comprises:
an image sensing device dividing the input image into a brightness (Y) signal and a color difference (R-Y/B-Y) signal and converting a Y/R-Y/B-Y signal into the color signal by using an RGB matrix; and
an illuminance measuring part measuring the illuminance by analyzing an RGB histogram based on the color signal output from the image sensing device.

3. The network camera of claim 2, wherein the image sensing device comprises a charge coupled device (CCD) sensor or a complementary metal oxide semiconductor (CMOS) sensor.

4. The network camera of claim 2, wherein the illuminance measuring part measures the illuminance at a preset time of period.

5. The network camera of claim 2, wherein the illuminance measuring part measures the illuminance by extracting a brightness component of the color signal.

6. The network camera of claim 2, wherein the illuminance measuring part measures the illuminance in a unit of one image frame or a preset number of images frames.

7. The network camera of claim 1, wherein the controller controls brightness of the lighting part through a pulse width modulation (PWM) signal.

8. The network camera of claim 1, wherein the controller stores a brightness level of lighting according to illuminance variation in a form of a look-up table.

9. A method of controlling lighting of a network camera, the method comprising:
dividing an image, which is input from an outside, into a brightness (Y) signal and a color difference (R-Y/B-Y) signal;
converting a Y/R-Y/B-Y signal into a color signal by using an RGB matrix;
measuring illuminance by analyzing an RGB histogram based on the color signal; and
automatically adjusting brightness of a lighting part based on information of the measured illuminance.

10. The method of claim 9, wherein, in the measuring the illuminance by analyzing an RGB histogram based on the color signal, the illuminance is measured at a preset time of period.

11. The method of claim 9, wherein, in the measuring the illuminance by analyzing an RGB histogram based on the color signal, the illuminance is measured by extracting a brightness component of the color signal.

12. The method of claim 9, wherein, in the measuring the illuminance by analyzing an RGB histogram based on the color signal, the illuminance is measured in a unit of one image frame or a preset number of images frames.

13. The method of claim 9, wherein, in the adjusting the brightness of the lighting part based on the information of the measured illuminance, brightness of the lighting part is controlled through a pulse width modulation (PWM) signal.
